(19) United States
(12) Patent Application Publication
(10) Pub. No.: US 2015/0264156 A1
(43) Pub. Date: Sep. 17, 2015

(54) SOFTWARE TOOL FOR CLIPPING AND PUBLISHING WEBSITE CONTENT

(71) Applicant: Everi, Inc., Wilmington, DE (US)

(72) Inventors: Asantha De Alwis, Brentwood (GB); Mridul Khariwal, London (GB); Ahmed Bhatti, Windsor (GB)

(73) Assignee: Everi, Inc., Wilmington, DE (US)

(21) Appl. No.: 14/204,436

(22) Filed: Mar. 11, 2014

(51) Int. Cl. H04L 29/06; G06F 17/30; H04L 29/08

(52) U.S. Cl. CPC H04L 67/42; H04L 67/02; G06F 17/3089

(57) ABSTRACT

A website publishing tool is disclosed. The tool comprises a bookmarklet that runs concurrently with a web browser on a user's computing device. The bookmarklet allows the user to select, clip, and publish content from a first web page. The bookmarklet communicates with a server, which stores the content. The user can publish the content into a second web page operated by a different web server. The second web page will include all of the functionality of the first web page.

### TECHNICAL FIELD

A website publishing tool is disclosed. The tool comprises a bookmarklet that runs concurrently with a web browser on a user's computing device. The bookmarklet allows the user to select, search, clip, and publish content from a first web page operated by a first server. The bookmarklet communicates with a second server, which stores the content. The content also is stored on the user's computing device. The user can publish the content into a second web page operated by a third server. The second web page will include all of the functionality and design elements of the first web page.

### BACKGROUND OF THE INVENTION

Website publishing tools are well known in the prior art. Such tools assist a user in building a web page or publishing content to a web page.

However, the prior art lacks a tool that enables a user to clip all or part of a first web page and to publish that content into a second web page while maintaining all of the original functionality and design of the first web page in the second web page. Existing tools that have attempted to do this have been unable to maintain all of the original functionality and design. In addition, using existing tools, a user can only update the second web page using an “admin” panel and not by using a web browser.

What is needed is a website publishing tool that enables a user to clip all or part of a first web page and to publish that content in a second web page while maintaining all of the original functionality and design of the first web page in the second web page. What is further needed is a tool that allows a user to perform these operations using a web browser and without using embedded code or APIs. What is further needed is a tool that allows a user to add content to a website in addition to publishing clipped content into that website.

### SUMMARY OF THE INVENTION

The aforementioned problems and needs are addressed through a website publishing tool. The tool comprises a bookmarklet that runs concurrently with a web browser on a user's computing device. The bookmarklet allows the user to select, search, clip, and publish content from a first web page. The bookmarklet communicates with a server, which stores the content. The user can publish the content into a second web page operated by a different web server. The second web page will include all of the functionality and design of the first web page.

### BRIEF DESCRIPTION OF THE DRAWINGS

FIG. 1 depicts an embodiment comprising a bookmarklet running on a computing device and communicating with a plurality of servers.

FIG. 2 depicts a user interface within a web browser for utilizing a bookmarklet.

FIG. 3 depicts communication between a computing device and server.

FIG. 4 depicts an embodiment comprising an application running on a computing device and communicating with a plurality of servers.

### DETAILED DESCRIPTION OF THE PREFERRED EMBODIMENTS

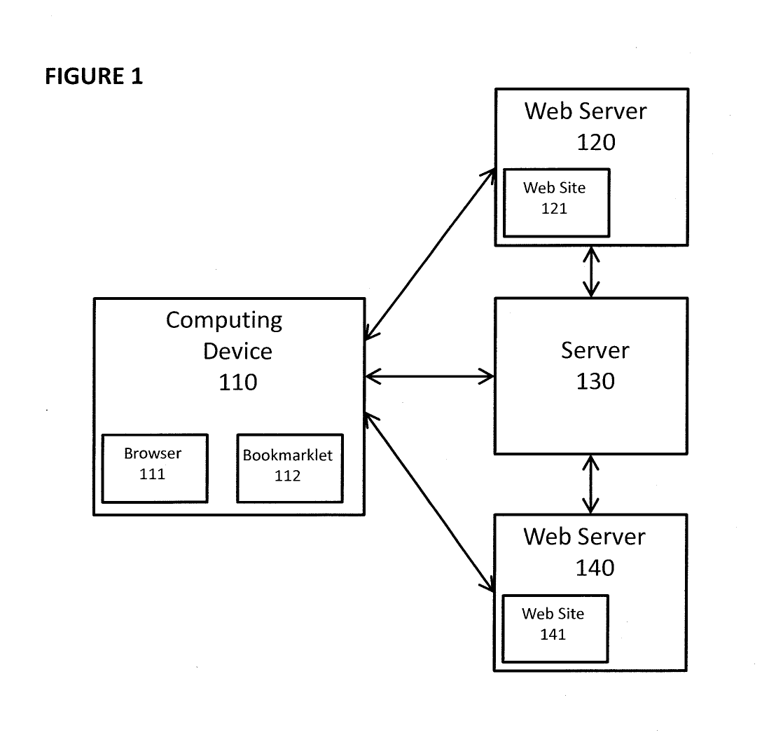

An embodiment is depicted in FIG. 1. A user operates computing device 110. Computing device 110 runs web browser 111 and bookmarklet 112. Web browser 111 and bookmarklet 112 are software applications comprising lines of code that are executed by computing device 110. Computing device 110 communicates with web server 120, server 130, and web server 140. Web server 120 hosts website 121, and web server 140 hosts website 141.

Computing device 110, web server 120, server 130, and web server 140 each comprise a processor, memory, non-volatile storage (such as a hard disk drive or flash memory array), and a network interface. Computing device 110 can be a desktop computer, notebook computer, mobile phone, tablet, or other computing device. Computing device 110, web server 120, server 130, and web server 140 communicate with one another over a network that can comprise wireless links, wired links, or a combination thereof.

Web server 120 and web server 130 also comprise web server software such as Apache or nGinx. Website 121 and website 141 are accessible by computing device 110 using known network techniques such as HTTP and HTTPS communication.

A user can operate computing device 110 to access website 121 using web browser 111. Bookmarklet 112 runs concurrently with web browser 111 and is accessible through web browser 111, such as through a toolbar. In one embodiment, bookmarklet 112 comprises a CSS file and JavaScript file that perform the functions described below.

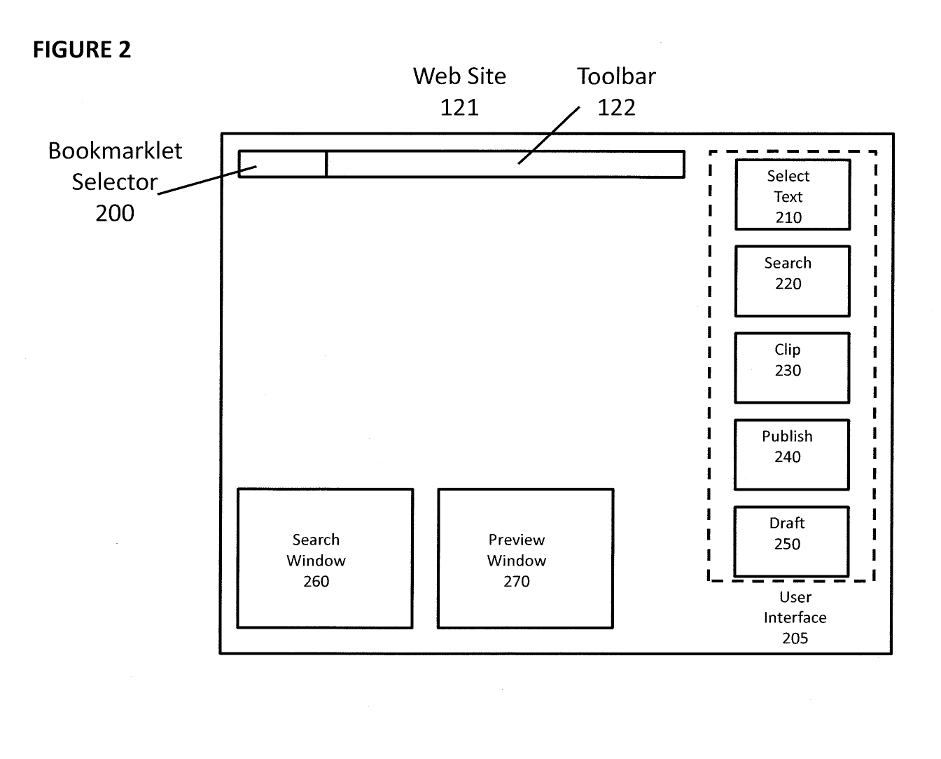

With reference to FIG. 2, the user of computing device 110 is accessing website 121 using web browser 111. He or she has selected bookmarklet selector 200, for example, on toolbar 122. Bookmarklet selector 200 is a user interface device such as a menu, menu item, button, or other known interface device. Selecting bookmarklet selector 200 causes bookmarklet 112 to launch user interface 205. Bookmarklet 112 provides the following options and functions to the user through user interface 205:
Select text: The user can select text that appears on web site 121 using the select text user interface device 210.
Search: The user can initiate a search using search user interface device 220. Bookmarklet 112 will open a new window that displays the results.
Select a website or portion thereof: The user can select website 121 or a portion thereof for clipping using clip user interface device 230.
Publish content: The user can select text or content from website 121 and publish it on a different web server or website using publish user interface device 240.
Draft: The user can draft an article or otherwise add to website 121 using draft user interface device 250. The user can draft and add content alongside clipped content that is published using publish user interface device 240.

Each of the user interface devices 210, 220, 230, and 240 are user interface devices such as menus, menu items, buttons, or other known interface devices.

If the user selects select text user interface device 210, the user can then select text on website 121. The user then can elect to perform a search using search user interface device 220 or publish the text using publish user interface device 240. Bookmarklet 121 will detect mouse up movements and will check window.getSelection( ) for a user selection. In addition, to copying the text, bookmarklet 121 will obtain the HTML range for the selection and allow the user to preview that range using preview window 270.

If the user selects search user interface device 220, then the user can select text that will serve as the basis for running a search, or alternatively, the user can enter a search query. Either action optionally causes server 130 to communicate with a another server using APIs to obtain search results or other content, such as a server for Bing, Google, Twitter, Youtube, The Guardian, BBC, NDTV, New York Times, USA Today. The results optionally will be posted in search window 260. The content of search window 260 is generated by server 130 as an HTML iframe,

If the user selects clip user interface device 230, the user will then be able to copy content from website 121 or search window 260. Bookmarklet 112 implements an event listener for clipping. A clip page button is shown which has a click handler attached to capture the html of the entire body element. As another option, there is a mouse move event that is being used to track where the mouse is at each pixel position, using window.getRangeQ to track which element the mouse is currently over and capture the outerhtml upon clicking In one embodiment, a red border is applied to the element to be clipped on hover. Elements that are selected for clipping are stored by server 130.

To preserve styling and functionality of the selected clipping, bookmarklet 112 copies all script, style, and link tags from website 121 for the selected clipping and that information is stored by server 130. All links on website 121 are converted to absolute paths (for example, by referring to web server 120) to prevent a web browser in a future session from trying to load assets server 130. In addition, the user can choose whether the published content will be automatically updated when website 121 is updated, or whether it will remain static and will not be automatically updated when website 121 is updated.

If the user selects publish user interface device 240, the content or text that was previously copied can be posted on a separate website, such as web site 141 hosted by a separate server, such as web server 140. Once a clip is posted to website 141, it will retain the content that is saved in server 130 at the time that web site 121 was clipped. Web site 141 posts an HTML iframe that is populated with content generated by server 130. . The user can create additional content alongside the clipped content using the Draft feature described previously.

A user also can perform a search of the title of his or her article or posting against other content on the Internet to determine if other articles exist with a similar title. This is performed when operating the Drafts functionality.

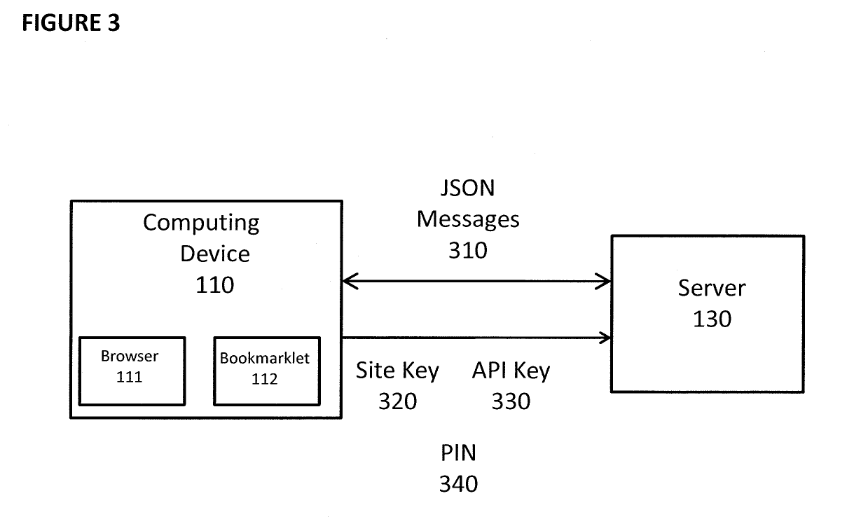

With reference to FIG. 3, computing device 110 and server 130 utilize a Javascript postMessage to exchange a json.stringified object, json messages 310. Computing device 110 operates a message listener operated by bookmarklet 121 that uses json.parse to parse json messages 310 and call the method passed inside the message along with all its arguments. Similarly, each iframe generated by server 130 will operate a message listener that uses json.parse to parse json messages 310 and call the method passed inside the message along with all its arguments.

Optionally, server 130 can perform an authentication process before posting clippings to web site 141. A user engaged in an activation process with server 130 by providing API key 330 and site key 320 previously issued by server 140 to provide admin privileges. Server 130 confirms this information with web server 140. Upon confirmation, server 130 saves the direct address of web server 140 in its database. Thereafter, server 130 will only post content to web site 141 if it receives the API key 330 and site key 320 from bookmarklet 121. This ensures that only authorized users are allowed to post content to web site 141.

In the alternative, instead of using API key 330 and site key 320 for authentication, server 130 can prompt the user for a PIN code 340 that had been previously assigned by server 140.

Some websites have content security policy headers that prevent server 130 (or other servers) from loading scripts and styles. To overcome this issue, bookmarklet 112 includes an extension to web browser 111 that rewrites the header being sent to include the domain for server 130 in the allowed whitelist.

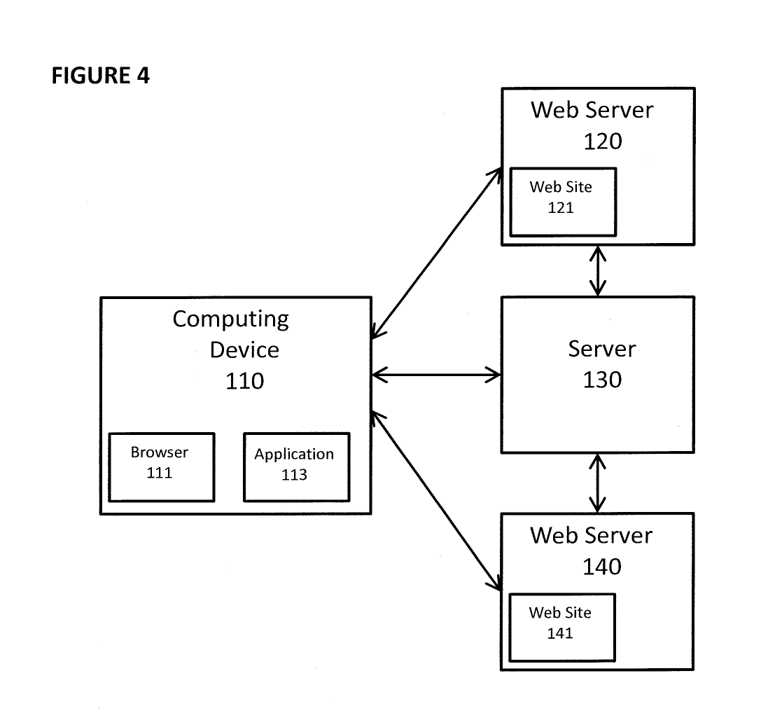

In another embodiment, shown in FIG. 4, the same functions provided by bookmarklet 112 described above are instead provided by application 113. Application 113 is a software application comprising lines of code that are executed by computing device 110. Application 113 runs concurrently with web browser 111 and enables the user to perform all of the functions that can be performed using bookmarklet 112.

Thus, using the embodiments described herein, a user is able to select, search, clip, and publish content from a first web page onto a second web page using a browser.

References to the present invention herein are not intended to limit the scope of any claim or claim term, but instead merely make reference to one or more features that may be covered by one or more of the claims. Structures, processes and numerical examples described above are exemplary only, and should not be deemed to limit the claims. It should be noted that, as used herein, the terms “over” and “on” both inclusively include “directly on” (no intermediate materials, elements or space disposed there between) and “indirectly on” (intermediate materials, elements or space disposed there between).

What is claimed is:

1. A method of publishing website content, comprising:
selecting, using a web browser running on a computing device, content on a first website generated by a first server;
storing the content on a second server; and
publishing the content on a second website generated by a third server.

2. The method of claim 1, wherein the publishing step comprises generating an iframe and populating the iframe with the content from the second server.

3. The method of claim 1, wherein the selecting step comprises operating a bookmarklet.

4. The method of claim 1, wherein the selecting step comprises selecting a web page or a portion of a web page.

5. The method of claim 1, wherein the selecting step comprises adding additional content to the second website in response to a user command.

6. The method of claim 1, further comprising the step of generating a window within the web browser and displaying a preview of the content.

7. The method of claim 3, wherein the operating step is initiated using a toolbar in the web browser.

8. The method of claim 1, further comprising the step of authenticating admin privileges before performing the publishing step.

9. The method of claim 1, further comprising the step of converting links to absolute paths.

10. The method of claim 1, further comprising the step of performing a search and displaying search results in a window within the web browser.

11. A computing device configured to capture website content, comprising:
a processor executing instructions stored in memory to:
operate a web browser;
enable a user to select content on a website accessed by the web browser; and
send the content to a server;

12. The computing device of claim 11, wherein the processor executes instructions stored in memory to operate a bookmarklet.

13. The computing device of claim 11, wherein the content comprises a web page from the website.

14. The computing device of claim 11, wherein the content comprises a portion of a web page from the website.

15. The computing device of claim 11, wherein the processor executes instructions stored in memory to generate a window within the web browser and display a preview of the content.

16. The computing device of claim 11, wherein the processor executes instructions stored in memory to provide authentication information to the server.

17. A system for publishing website content, comprising:
a first server providing a first website;
a computing device running a web browser for accessing the first website and for selecting content from the first website;
a second server for receiving the content from the computing device and transforming the content to generate transformed content; and
a third server for receiving the transformed content from the second server and for providing the transformed content on a second website.

18. The system of claim 17, wherein the computing device runs a bookmarklet.

19. The system of claim 17, wherein the computing device is a mobile phone.

20. The system of claim 17, wherein the computing device is a tablet.
